(19) United States
(12) Patent Application Publication
(10) Pub. No.: US 2023/0018323 A1
(43) Pub. Date: Jan. 19, 2023

(54) FISHING ROD AND REEL RECOVERY DEVICE AND RECOVERY SYSTEM

(71) Applicant: ALAN REX NORRIS, Southport, NC (US)

(72) Inventor: ALAN REX NORRIS, Southport, NC (US)

(21) Appl. No.: 17/369,263

(22) Filed: Jul. 7, 2021

(51) Int. Cl. A01K 87/00; A01K 93/00; B63C 7/00

(52) U.S. Cl. CPC A01K 87/007; A01K 93/00; B63C 7/00

(57) ABSTRACT

The present invention comprises a reusable recovery system for sport fishing rod-and-reel combinations that are dropped overboard, which floats the fishing rod-and-reel to the surface of the water. The core components of the invention are a hollow tube, a gas cartridge, an inflatable bag, configured as follows: a tube is attached to the fishing rod handle as not to interfere with normal fishing operations, a gas cartridge with the discharge side of the cartridge pointed toward the open end of the tube, an inflatable bag is folded to fit in the tube and attached to receive the gas when discharged, the open end of the tube has a cap that allows water to enter at a certain depth of water. In some embodiments the invention can be used to recover gear lost overboard on a boat, like a fishing rod and reel.

### BACKGROUND

This invention relates generally to, but is not limited to, recovering fishing rods when dropped in water.

The equipment used by sport fishing enthusiasts has evolved into fishing rods constructed of high-tech materials, such as carbon fiber, and precision reels machined from exotic metals. These rod-and-reel combinations have become increasingly expensive. During the frantic action immediately after hooking a sport fish, it is common occurrence for this fishing gear to be dropped overboard or pulled from the user's hands by the hooked fish. Once the fishing gear goes overboard it will sink to the bottom and is lost forever.

Currently, there are a number of solutions to recover fishing rods and reels if dropped overboard. Some of these solutions attempt to use foam wrapped around the rod handle, a float/buoy system, or a system of pistons fired by a dischargeable gas, but these solutions fail to meet the needed solution because they are difficult to use, and interfere with the normal handling and operation of the fishing rod and reel.

Examples of using the invention would be screwing the invention into a fishing rod handle.

Therefore, a need exists for a novel device to recover lost gear automatically.

### BRIEF SUMMARY OF THE INVENTION

It is desirable to have a system to attach to high-value fishing and other gear aboard a boat in case the gear is dropped overboard and have the recovery system float the gear back to the surface of the water. Furthermore, it is desirable that the inflatable recovery system be easily replaceable for reuse after activation and use. Furthermore, it is desirable to that the inflatable recovery system be highly visible to make retrieval easy. The disclosed invention advantageously fills these needs and addresses the aforementioned deficiencies by providing an easy to use, screw in or other attaching method device that is replaceable if used and easily deployed.

Disclosed is a fishing rod and reel recovery system, comprising the following components: (1) a hollow tube, open at one end and closed at the other end; (2) a gas cartridge; (3) a water soluble trigger to release the gas; (4) an air bag; (5) a cap to close the otherwise open end of the tube; (6) the cap comprising a pressure activated water valve.

These components generally speaking, are configured as follows: (1) the gas cartridge is connected at the closed end of the hollow tube with the gas discharge pointed in the direction of the open end of the tube; (2) the open end of the airbag is attached to the gas cartridge so that when the gas is discharged the air bag is inflated; (3) the un-inflated airbag is fan-folded so that the entire bag fits inside the tube; (4) the cap is fitted to the open end of the tube.

The fishing rod and reel recovery system may also have one or more of the following: secondary activation systems for greater depth, more than one gas cartridge and inflatable bags to discharge in parallel or series, a rope or other connecting device to allow the system to function as a gear recovery tool.

The disclosed fishing rod and reel recovery system is unique when compared with other known devices and solutions because it provides: (1) for operation without interfering with how the fishing rod and reel are used by the operator; (2) allowing the fishing rod and reel to continue to fit in sport fishing rod holders aboard a boat; (3) is reusable; and (4) it does not require complex setup procedures such as feeding a fishing line through a buoy, (5) does not use a movable piston or any other means for ejecting the inflatable bag; (6) it does not interfere with the operation of the fishing rod and reel.

The disclosed fishing rod and reel recovery system is unique in that it is structurally different from other known devices or solutions. More specifically, the device is unique due to the presence of (1) a hollow tube that can vary in size and adapt to different fishing rods; (2) a hollow tube that can be made of different materials; (3) a cap that can be changed to work under different conditions; (4) a water soluble trigger to activate the gas cartridge; (5) requires no pistons or other movable parts to eject the air bag.

### BRIEF DESCRIPTION OF THE DRAWINGS

The present invention is illustrated by way of example, and not by way of limitation, in the figures of the accompanying drawings.

While aspects of the present invention will be described with reference to the details of the embodiments of the invention shown in the drawings (and some embodiments not shown in the drawings), these details are not intended to limit the scope of the invention.

FIG. 1. A side view of a fishing rod and reel recovery system showing the unassembled components.

FIG. 2. A planar view of a fishing rod and reel recovery system showing the unassembled components.

FIG. 3. A side view of a fishing rod and reel recovery system attached to a hypothetical fishing rod.

FIG. 4. A planar view of the preferred basic embodiment of the fishing rod and reel recovery system's components, assembled.

FIG. 5. A side view of the fishing rod and reel recovery system under the surface of the water prior to deployment.

FIG. 6. A side view of the fishing rod and reel recovery system under the surface of the water during deployment.

FIG. 7. A side view of the fishing rod and reel recovery system on the surface of the water during deployment awaiting recovery.

List of Figure Items

| | |
|---|---|
| 000 | The fishing rod and reel recovery system |
| 001 | A hypothetical fishing rod |
| 002 | The hollow tube |
| 003 | The closed end of the hollow tube |
| 004 | The the open end of the hollow tube |
| 005 | The adhesive to hold the gas cartridge |
| 006 | The gas cartridge |
| 007 | The air bag |
| 008 | The open end of the air bag |
| 009 | The water-soluble trigger |
| 010 | The cap |
| 011 | The optional water inlet valve |
| 012 | The water inlet |

### DETAILED DESCRIPTION

The following description is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the following description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

The order of the steps of disclosed processes may be altered within the scope of the invention.

For the purposes of promoting an understanding of the principles of the present invention, reference will now be made to the embodiments illustrated in the drawings and specific language will be used to describe the same, only as examples and not intended to be limiting.

Fishing rods and reels (hereafter referred to as “fishing rods”), as used herein may be, but are not limited to, offshore rods, surf rods, travel and pack rods, ice rods, center-pin and float rods, fly and spey rods, trolling rods, casting rods, or spinning rods.

Some embodiments of versions of the present invention can comprise (1) a hollow tube, open at one end and closed at the other end; (2) a gas cartridge; (3) a water soluble trigger to release the gas; (4) an air bag; (5) a cap to close the otherwise open end of the tube; (6) the cap comprising a pressure activated water valve.

In some embodiments of the present invention the tube may be made of materials like, but not limited to, metal, plastic, fiberglass, or carbon fiber.

In some embodiments of the present invention the tube is of a diameter equal to the inside diameter of a fishing rod handle. Fishing rod handles vary in size depending on the purpose of said fishing rod thus the diameter for example, and not meant to be limiting, of the tube may range from 0.25 inches to 4 inches.

In some embodiments of the present invention the gas cartridge has a water soluble trigger.

In some embodiments of the present invention the air bag material may be made of, but not limited to, materials like nylon, polyester, plastic, or rubber. The material will hold a gas and float in water, but can be compactly folder.

In some embodiments of the present invention the cap may be made of materials like, but not limited to, metal, plastic, fiberglass, or carbon fiber.

The cap comprises a method for the airbag to eject the the entire cap or a portion of the cap as the airbag inflates.

In some embodiments of the present invention the cap with may be connected to the hollow tube by threading, whether on the inside or outside of the hollow tube.

In some embodiments of the present invention the cap may push onto the hollow tube.

In some embodiments of the present invention the cap comprises a water inlet valve.

In some embodiments of the present invention the cap comprises a water inlet valve that opens at different depths due to the depth of the water.

In some embodiments of the present invention the cap may have holes.

In some embodiments of the present invention the normally closed end of the hollow tube comprises an attachment device with interchangeable fittings to fit the entire invention to the Fishing Rod.

In some embodiments of the present invention in its complete version, the invention is made up of the following components: (1) a thin stainless steel hollow tube approximately one and one-quarter inches in diameter and six to twelve inches long; (2) one end of the thin stainless steel hollow tube being closed and the other end of the tube being open; (3) a gas cartridge; (4) a water soluble trigger to release the gas; (5) one nylon fabric air bag approximately eighteen inches in diameter when inflated; (6) the cap comprising a pressure activated water valve.

In some embodiments these components are connected as follows to result in a single system: (1) the gas cartridge is connected at the closed end of the hollow tube with the gas discharge pointed in the direction of the open end of the tube; (2) the open end of the airbag is attached to the gas cartridge so that when the gas is discharged the air bag is inflated; (3) the un-inflated air bag is fan-folded so that the entire bag fits inside the tube; (4) the cap is fitted to the open end of the tube.

In some embodiments of the present invention the gas cartridge is held in place at the closed end of the tube by an adhesive.

In some embodiments of the present invention the normally closed end of the hollow tube comprises a threaded cap with an attachment device for the gas cartridge.

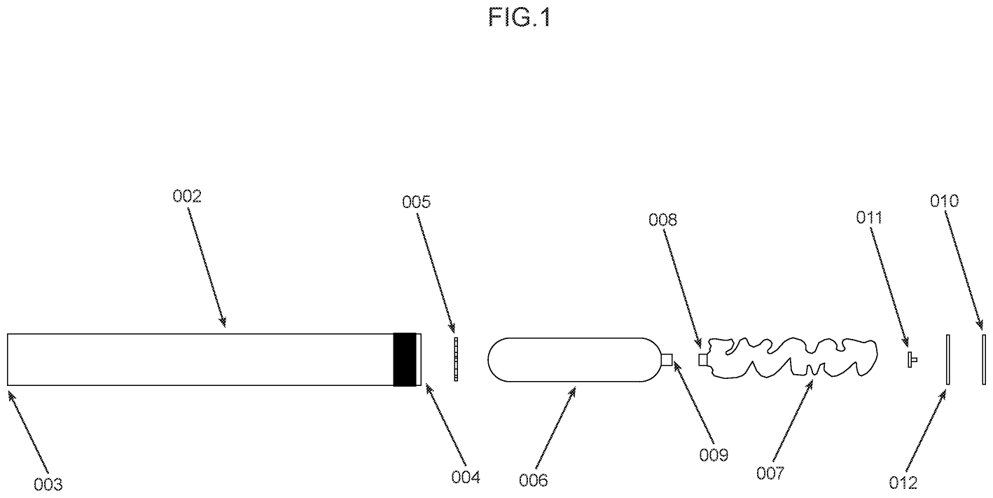

FIG. 1. A side view of the preferred basic embodiment of the invention's components, unassembled. In one embodiment the hollow tube 002 is closed 003. The hollow tube 002 has an open end 004. An adhesive 005 is connects the gas cartridge 006 to the closed end 003 of the hollow tube 002. A water soluble trigger 009 holds the gas in the gas cartridge. The inflatable bag 007 is connected at the open end of the 008 of the inflatable bag 007 to the gas discharge and trigger 009 of the gas cartridge 006. A cap 010 is used to secure a an optional water pressure inlet valve 012 and the water inlet 011 that are connected to the open end 004 of the hollow tube 002.

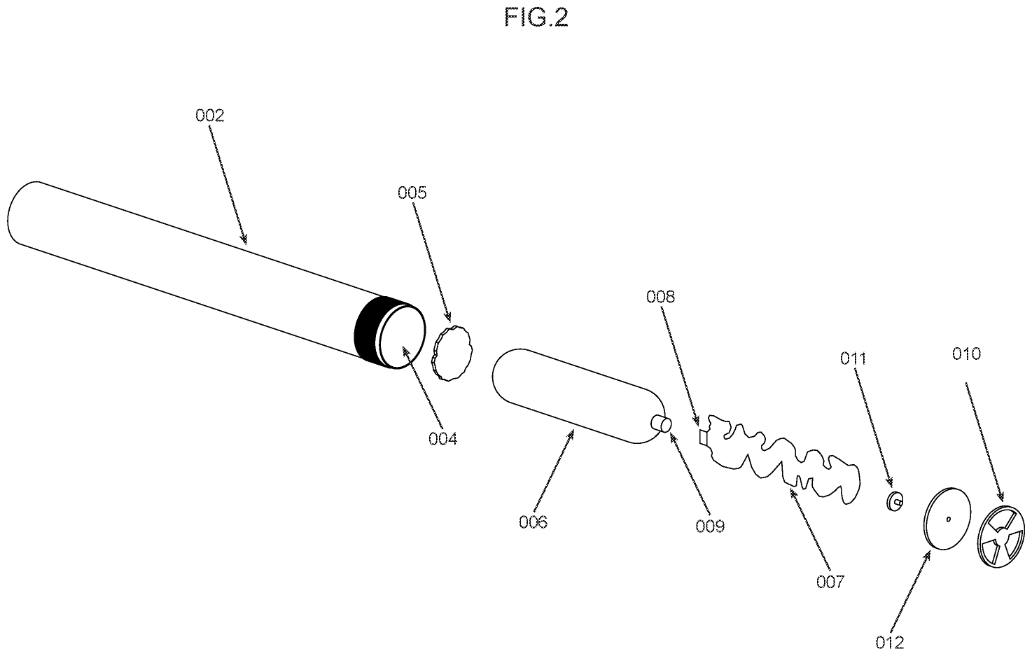

FIG. 2. A planar view of the preferred basic embodiment of the invention's components, unassembled. In one embodiment the hollow tube 002 is closed 003. The hollow tube 002 has an open end 004. An adhesive 005 is connects the gas cartridge 006 to the closed end 003 of the hollow tube 002. A water soluble trigger 009 holds the gas in the gas cartridge. The inflatable bag 007 is connected at the open end of the 008 of the inflatable bag 007 to the gas discharge and trigger 009 of the gas cartridge 006. A cap 010 is used to secure a an optional water pressure inlet valve 012 and the water inlet 011 that are connected to the open end 004 of the hollow tube 002.

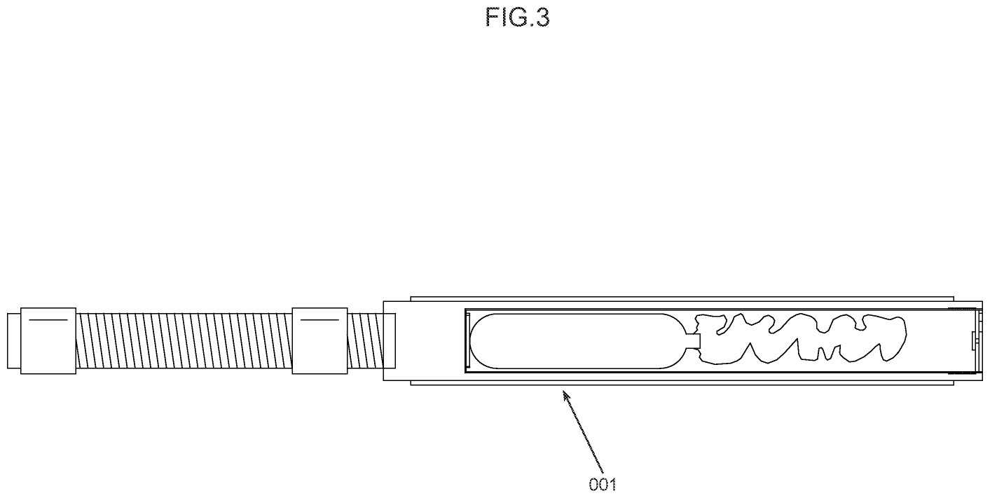

FIG. 3. A side view of a fishing rod and reel recovery system assembled and attached to a hypothetical fishing rod 001.

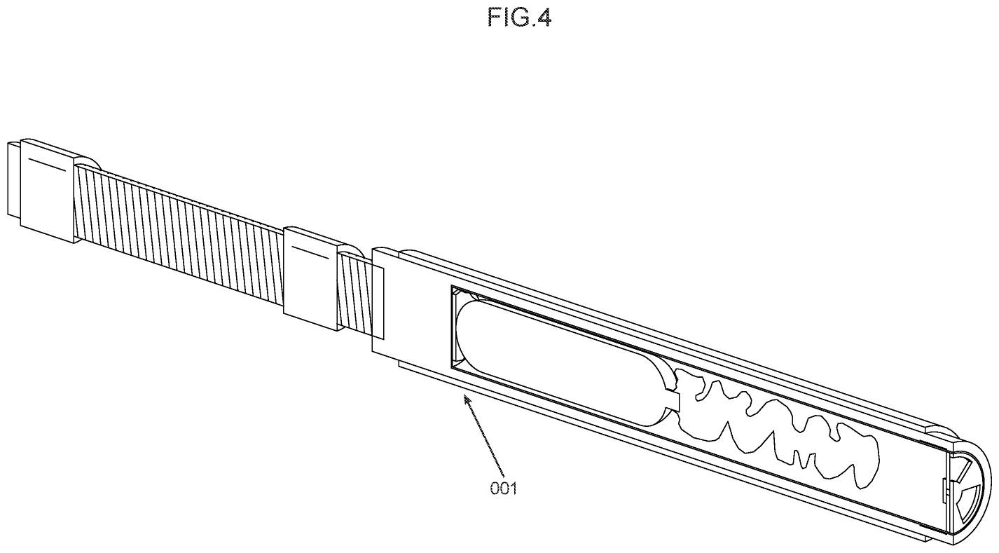

FIG. 4. A planar view of the preferred basic embodiment of the invention's components assembled and attached to a hypothetical fishing rod 001.

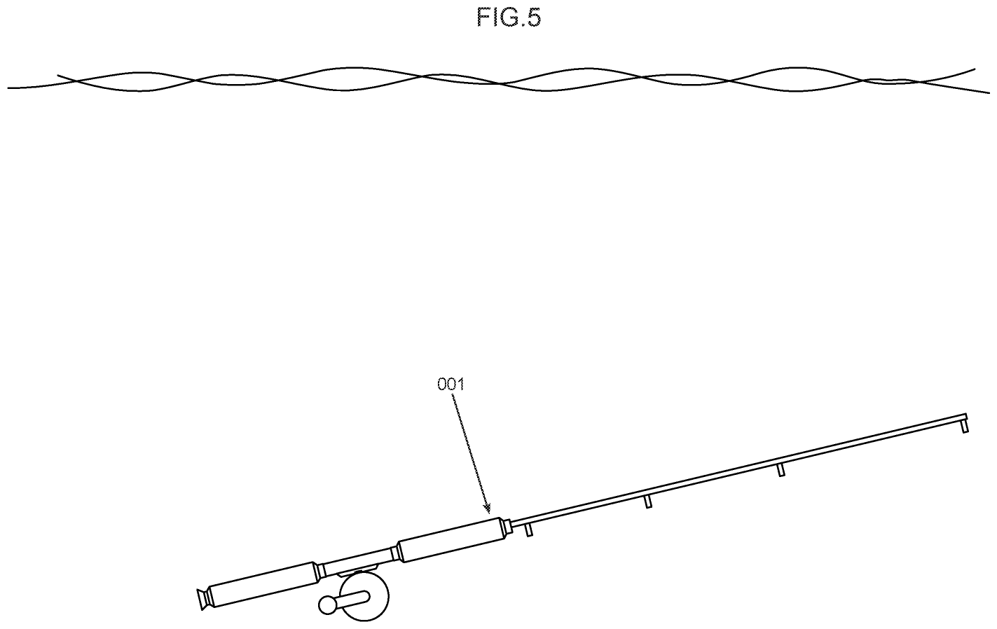

FIG. 5. A side view of the invention under the surface of the water prior to deployment as part of a hypothetical fishing rod 001.

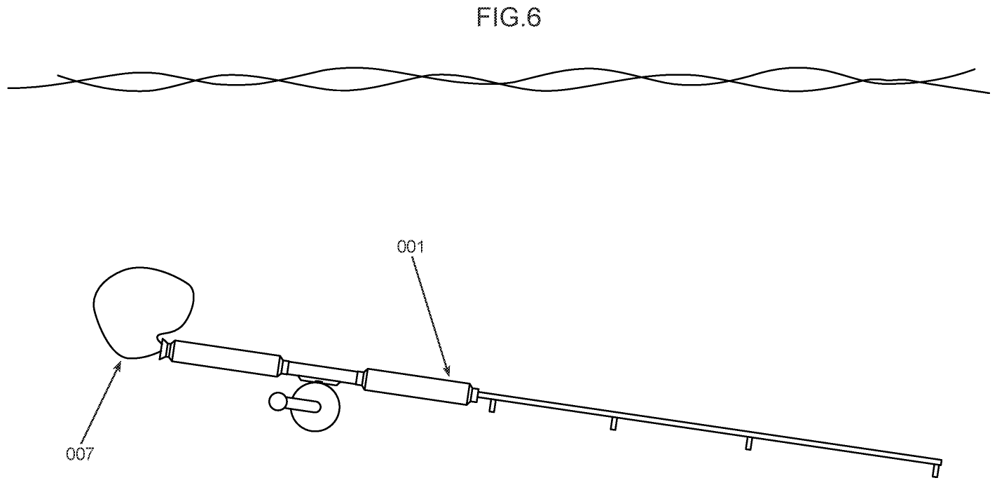

FIG. 6. A side view of the invention under the surface of the water during deployment.

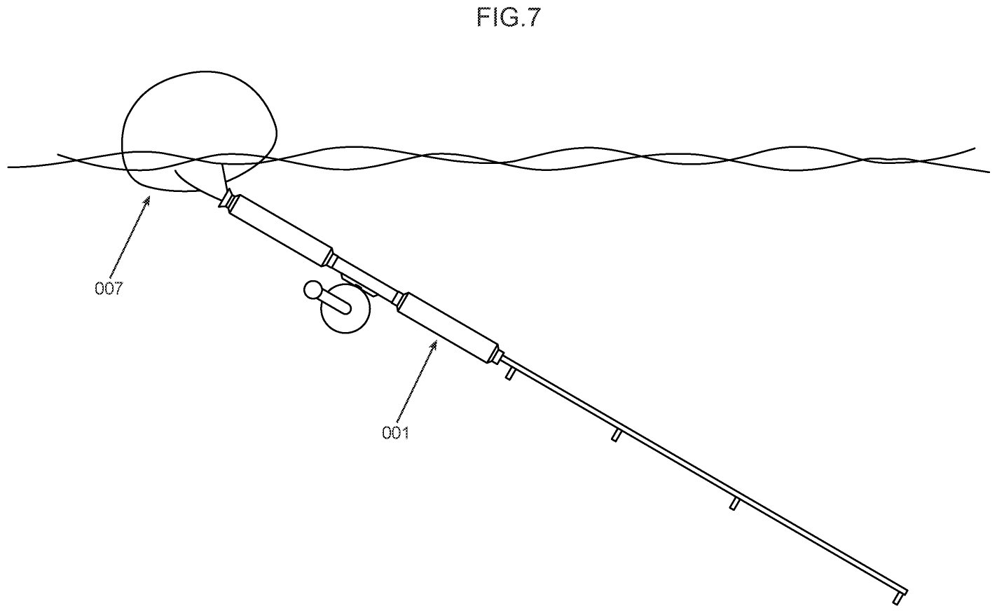

FIG. 7. A side view of the invention on the surface of the water during deployment awaiting recovery.

Versions of the invention may be a method of adapting a fishing rod with a fishing rod and reel recovery system, comprising: selecting a fishing rod appropriate for installation of said fishing rod and recovery system; and using a fishing rod and reel recovery system comprising a hollow tube; a gas cartridge; an inflatable bag; a cap to close the otherwise open end of the tube; a water pressure inlet valve to allow water into the hollow tube at different depths; a water soluble trigger to release the gas.

Versions of the fishing rod and reel recovery system may be made individually, in batches, or via continuous assembly.

For example, to make a version of the fishing rod and reel recovery system prepare an appropriate work surface and assemble all of the components disclosed herein. Assembled the components in a logical order as someone skilled in the art would do. For example, start with a hollow tube; a gas cartridge; an inflatable bag; a cap to close the otherwise open end of the tube; a water pressure inlet valve to allow water into the hollow tube at different depths; and a water soluble trigger to release the gas. Connect the gas cartridge to the closed end of the hollow tube; connect the inflatable bag to the gas cartridge with the water soluble trigger; close the otherwise open end of the open tube with the cap and water pressure inlet valve.

To use the assembled version of the fishing rod and reel recovery system select an appropriate fishing rod and connect the tube to the handle of the fishing rod.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of the present invention may be utilized individually, concurrently, or in any sequential combination.

Those skilled in the art to which this application relates will appreciate that other and further additions, deletions, substitutions and modifications may be made to the described embodiments.

What is claimed:

1. A fishing rod and reel recovery system, comprising:
a hollow tube of a given length, width, and depth;
a gas cartridge attached to the closed end of the hollow tube;
a water soluble trigger to release the gas;
an inflatable bag attached to the gas cartridge; and
a cap to close the otherwise open end of the tube.

2. The fishing rod and reel recovery system of claim 1 wherein said hollow tube further comprising:
a threaded adapter to attach to a fishing rod.

3. The fishing rod and reel recovery system of claim 1 wherein said gas cartridge further comprising:
a CO2 gas cartridge.

4. The inflatable bag recited in claim 1 is attached to the discharge of said gas cartridge and folded to fit inside said hollow tube.

5. The fishing rod and reel recovery system of claim 1 wherein said cap further comprising:
a pressure activated water inlet valve.

6. The fishing rod and reel recovery system of claim 1 further comprising a fishing rod.

7. A fishing rod and reel recovery device, comprising:
a hollow tube of a given length, width, and depth;
a gas cartridge attached to the closed end of the hollow tube;
a water soluble trigger to release the gas;
an inflatable bag attached to the gas cartridge; and
a cap to close the otherwise open end of the tube.

8. A method of adapting a fishing rod with a fishing rod and reel recovery system, comprising:
selecting a fishing rod appropriate for installation of said fishing rod and recovery system; and
using a fishing rod and reel recovery system comprising a hollow tube; a gas cartridge; an inflatable bag; a cap to close the otherwise open end of the tube; a water soluble trigger to release the gas; and
wherein connecting the fishing rod and reel recovery system to said fishing rod results in protecting the fishing rod when dropped into water.
